(19) United States
(12) Patent Application Publication
(10) Pub. No.: US 2010/0067324 A1
(43) Pub. Date: Mar. 18, 2010

(54) METHOD FOR CALIBRATING AN ULTRASONIC SENSOR AND ULTRASONIC DISTANCE MEASURING APPARATUS

(76) Inventor: Peter PREISSLER, Dorndorf (DE)

Correspondence Address: KENYON & KENYON LLP, ONE BROADWAY, NEW YORK, NY, 10004, US

(21) Appl. No.: 12/092,686

(22) PCT Filed: Sep. 6, 2006
(86) PCT No.: PCT/EP06/66090

§ 371 Date: Sep. 26, 2008

(30) Foreign Application Priority Data
Nov. 4, 2005 (DE) 102005052633.0

(51) Int. Cl. H04B 17/00

(52) U.S. Cl. 367/13

(57) ABSTRACT

In a method for calibrating an ultrasonic sensor, and an ultrasonic distance-measuring device a crosstalk signal is transmitted from a first ultrasonic sensor to a second ultrasonic sensor. The amplitude of the crosstalk signal is compared with a stored value, and the sensitivity of the sensor is set as a function of comparison.

### FIELD OF THE INVENTION

The present invention is based on a method for calibrating an ultrasonic sensor, and on an ultrasonic distance-measuring device.

### BACKGROUND INFORMATION

Certain distance-measuring devices using ultrasonic sensors are conventional in which a sensor sends out an ultrasonic signal and the ultrasonic signal is reflected by an obstacle. The same sensor, or another sensor, receives the reflected signal. Taking into account the speed of sound, a distance to the obstacle is determined from the propagation time of the ultrasonic signal from the sensor to the obstacle and back to a sensor.

German Published Patent Application No. 199 24 755 describes a distance-measuring device in which a second ultrasonic unit is capable of receiving the wave signals emitted by the first unit as crosstalk signals. Here, an interference-determining device is provided in which the intensity of the crosstalk signal is evaluated. If the intensity is less than a prespecified threshold, the presence of interference is determined. In this way, the driver can be warned ahead of time that the sensor has lost its functional capacity due to increasing blinding, in particular due to the accumulation of snow, ice, or dirt, and may no longer be capable of detecting an obstacle.

### SUMMARY

In contrast, the method according to example embodiments of the present invention for calibrating an ultrasonic sensor provide that the sensitivity of the ultrasonic sensor is set as a function of received crosstalk signal. Here, a crosstalk signal is an ultrasonic signal that has arrived at the ultrasonic sensor that is to be calibrated from an additional ultrasonic sensor situated adjacent thereto, without being reflected by an obstacle. Here, the crosstalk signal can be on the one hand the same sound transmitted between the sensors via a direct path through the air. In addition, it is also possible for the sound to have propagated along or through a common carrier of the two sensors. By adapting the sensitivity of the sensor that is to be calibrated, it is possible to respond to a deterioration of the receive capacity of the sensor. Thus, if the sensor is adversely affected in its receive capacity by dirt or ice, within at least a certain scope it is possible to react to this by changing the sensitivity. In addition, however, it is also possible to respond to aging processes of the sensor, in particular to decreasing sensitivity of the sensor resulting from increasing age, and to carry out a corresponding readjustment of the sensitivity. In addition, a regulation according to example embodiments of the present invention avoids setting the sensor to be too sensitive. This is because a sensor that is set to be too sensitive may also detect interference signals, due for example to reflections from the ground or to other sound signals, so that what are referred to as pseudo-obstacles (i.e., obstacles that are suspected but not actually present) can cause a warning to be outputted in the vehicle. Such unnecessary warnings can be avoided by adapting the sensitivity to the functional capacity of the sensor.

Through the measures described herein, advantageous developments and improvements of the method are possible. It is particularly advantageous to increase the sensitivity of the sensor as an amplitude decreases. In particular, it is possible to increase the sensitivity of the sensor in linear fashion as the amplitude decreases. In this manner, a good adaptation of the sensitivity is possible.

In addition, it is advantageous to output an error message when a prespecified magnitude of the amplitude is undershot. In this way, when interference with the sensor is too great, an attempt is no longer made to carry out a measurement. Below this limit, an orderly functioning of the sensor can no longer be ensured due to a too-great attenuation or other disturbance.

In addition, it is advantageous to set a stored value for the comparison with the amplitude of the received signal in a separate calibration step. This separate calibration step should take place under the best possible conditions, in which the receive capacity of the sensor should be optimal. In this manner, the sound transmission of a crosstalk signal can be readily acquired. Through the separate calibration, the value used for the comparison can be adapted to the actual installation conditions of the sensor. On the one hand, in this manner manufacturing-related scatter can be corrected, and on the other hand it is possible, in particular in the case of retrofit equipment, to carry out a calibration after the installation.

In addition, an ultrasonic distance-measuring device is advantageous in which, in particular, the sensors are situated in a bumper of the vehicle. This provides easy installation, and in particular also easy retrofitting of the sensors.

In addition, it is advantageous to provide a non-volatile storage device for storing the value for the comparison with the amplitude of the received signal. In this manner, the value is available even after the vehicle has been shut off.

Exemplary embodiments of the present invention are shown in the drawing and are explained in more detail in the following description.

### BRIEF DESCRIPTION OF THE DRAWINGS

FIG. 1 shows a schematic representation of a vehicle rear end, in a top view,

FIG. 2 shows a schematic representation of a distance sensor, in a detail view,

FIG. 3 shows a representation of an envelope of a received signal of an ultrasonic sensor having sensitivity levels determined in the manner according to example embodiments of the present invention,

FIGS. 4 and 5 show exemplary embodiments of the representation of a dependence according to the present invention of the sensitivity on the comparison with a prespecified value,

FIG. 6 shows a sequence of a method according to example embodiments of the present invention.

### DETAILED DESCRIPTION

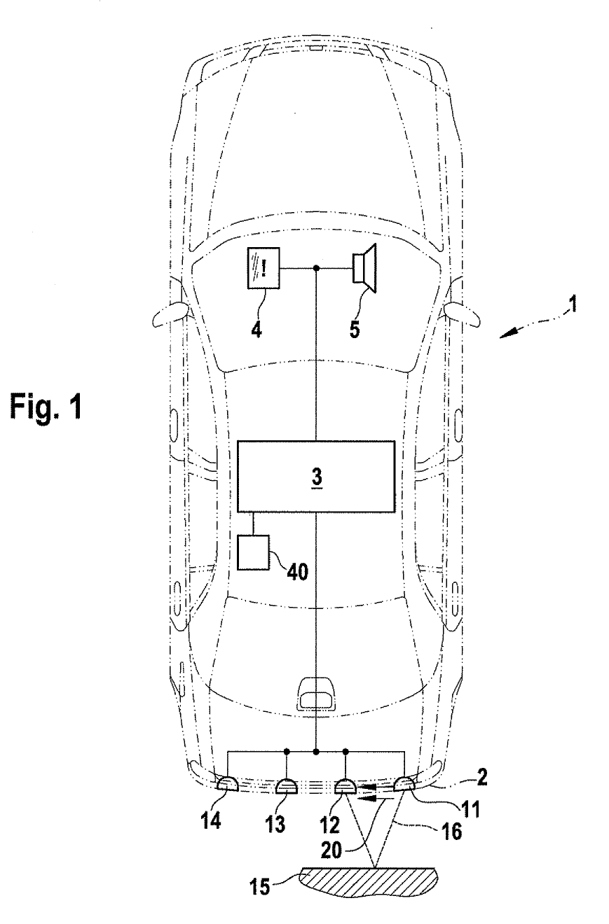

FIG. 1 shows a motor vehicle 1 on whose rear bumper 2 ultrasonic distance sensors are mounted. A corresponding arrangement can also be transferred to an arrangement on the front side of a vehicle in a corresponding manner. Instead of mounting in the bumper, arbitrary other installations of the ultrasonic sensors on the vehicle are also possible. However, the situation on the bumper offers the advantage that the ultrasonic distance sensors are first assembled to the bumper, and this bumper can then subsequently be connected to the vehicle.

In the example embodiment shown here, four ultrasonic distance sensors 11, 12, 13, 14 are situated next to one another on bumper 2. In this manner, the entire rear side of the vehicle is to be covered as well as possible by ultrasound distance sensors 11, 12, 13, 14. The ultrasound distance sensors are connected to an evaluation unit 3 that controls ultrasound distance sensors 11, 12, 13, 14 and evaluates the measurement results supplied by the ultrasound distance sensors. Evaluation unit 3 causes the ultrasound distance sensors to emit ultrasound signals that are reflected by an obstacle. In the exemplary embodiment shown here, an obstacle 15 is indicated in broken lines. The measurement of an obstacle can take place for example in that first ultrasonic sensor 11 sends out a signal 16 that is reflected by obstacle 15 and is received by second ultrasonic sensor 12 (cross-echo measurement). If a distance from an obstacle is undershot, evaluation unit 3 causes an optical warning to be outputted via a display 4 and/or causes an acoustic warning to be outputted via a loudspeaker 5.

If first ultrasonic sensor 11 is caused to emit an ultrasonic signal, waves are not only radiated in the direction of an obstacle; rather, waves can also reach second ultrasonic sensor 12 via the bearer construction of bumper 2, as well as immediately through the air, without being reflected by the obstacle. According to example embodiments of the present invention, these ultrasonic signals that are transmitted immediately from first ultrasonic sensor 11 to second ultrasonic sensor 12 are evaluated in order to calibrate the sensitivity of second ultrasonic sensor 12. Conversely, in a corresponding manner second ultrasonic sensor 12 can also be used to calibrate first ultrasonic sensor 11.

The same holds for third ultrasonic sensor 13 and fourth ultrasonic sensor 14. Here, constructions are also possible having more or fewer ultrasonic sensors in a mounting region, here e.g. in the area of bumper 2.

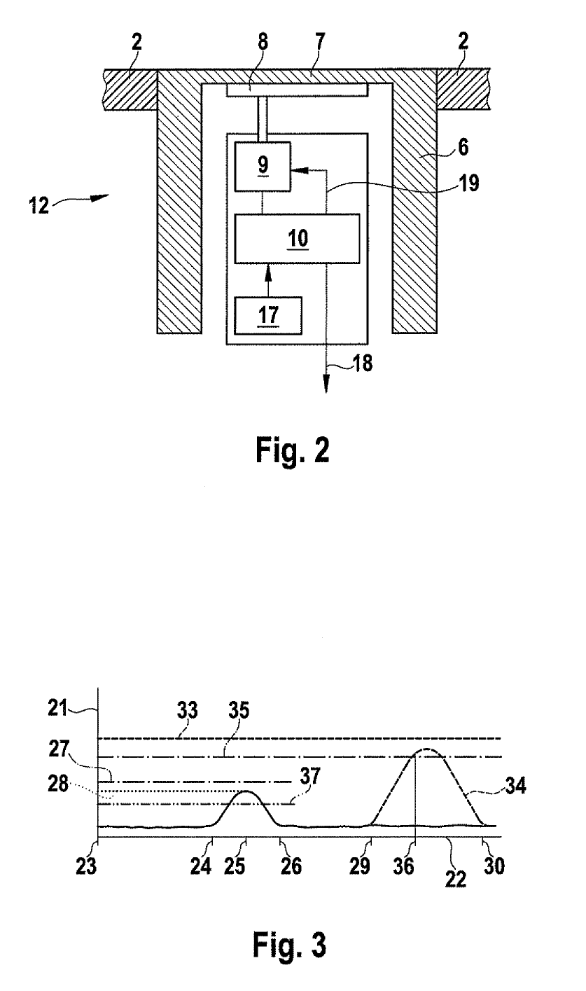

FIG. 2 provides a detailed explanation of the functioning of an ultrasonic sensor, e.g. of first ultrasonic sensor 11. Ultrasonic sensor 11 has a pot-shaped ultrasonic transducer 6. Ultrasonic transducer 6 has a base surface 7 that is embedded in bumper 2 such that it is oriented outward relative to the vehicle on which ultrasonic sensor 11 is mounted. Piezoelement 8 is situated on the side of base surface 7 facing away from the outer side. Piezoelement 8 is acoustically coupled to base surface 7. When piezoelement 8 is excited to vibration, base surface 7 is then also excited to vibration. In this way, piezoelement 8 is capable of producing ultrasonic waves and emitting them to the surrounding environment through a resonance of base surface 7. In addition to propagation through the air, the ultrasonic signals can also propagate in bumper 2. Ultrasonic sensor 11 operates as a detector in that base surface 7 can also be excited to vibration by ultrasonic waves. This vibration is communicated to piezoelement 8, which is compressed and expanded by the vibrations, so that an electrical voltage can be picked off at piezoelement 8. This voltage is conducted to an amplifier 9. Amplifier 9 forwards an output signal to an evaluation unit 10. In evaluation unit 10, an envelope of the received ultrasonic signal is compared with a prespecified threshold value. If the magnitude of the amplitude of the envelope is greater than the predetermined threshold value, the reception of a signal is detected. Here, the threshold value is preferably stored in a non-volatile storage device 17. A result of a detection of a received signal is communicated to evaluation unit 3 via a terminal 18.

In an example embodiment, an indirect measurement of the amplitude is also possible via the ultrasonic signal itself. In particular, if the signal shape of the envelope of the emitted ultrasound signal is always essentially the same, the maximum amplitude of the envelope can be inferred via an evaluation of how often the sound signal exceeds a prespecified boundary value. Because the same distance is always present between the sensors, a generally distance-dependent signal broadening cannot adversely affect this evaluation. Thus, without measuring the absolute, maximum amplitude, from the number of times a boundary value is exceeded during the reception of a single emitted sound pulse its maximum amplitude can be inferred: the more often the sound signal exceeds the boundary value during the reception of the sound pulse, the higher the maximum amplitude of the envelope of the received sound pulse. This relation can be determined for example as a function of sensor type during its manufacturing, or during an installation of the sensors in the vehicle.

According to example embodiments of the present invention, evaluation unit 10 has a stored value for comparison with the maximum amplitude of an ultrasonic signal produced by an adjacent sensor and transmitted immediately to the receiving sensor without being reflected. This value is preferably also stored in non-volatile storage device 17. Amplifier 9 on evaluation unit 10 is readjusted dependent on a value of the magnitude of the maximum amplitude of the envelope of this crosstalk signal. For example, if the maximum of the acquired amplitude of the envelope of the crosstalk signal sinks below a prespecified value, evaluation unit 10 for example increases the gain factor of amplifier 9 via back-coupling 19. An example of a corresponding regulation can be seen in FIG. 3. On y-axis 21, the amplitude of the envelope of the received ultrasonic signal is plotted. X-axis 22 is the time axis. At a time 23, first ultrasonic sensor 11 sends out a sound signal. This sounds signal also propagates in the direction of arrows 20 according to FIG. 1, in the direction of second ultrasonic sensor 12. Evaluation unit 3 has caused first ultrasonic sensor 11 to emit the signal, and at the same time switches second ultrasonic sensor 12 to a receive operating mode. Second ultrasonic sensor 12 does not emit a signal, but rather listens for received signals. At a subsequent time 24, the base surface begins to vibrate as a result of the incoming crosstalk signal from first ultrasonic sensor 11. At a subsequent time 25, the amplitude reaches its maximum. Subsequently, the amplitude decreases until a time 26. A background noise is always present due to general sound events in the vicinity of the vehicle. At time 25, the amplitude can exceed a first boundary value 37. This first boundary value 37 is provided for the determination of the proper functioning of second ultrasonic sensor 12. If this first boundary value 37 is not exceeded, a state of non-functioning of second ultrasonic sensor 12 is determined. In this case, it would not make sense to carry out a further measurement, due to the excessive limitation of the functioning of second ultrasonic sensor 12. A corresponding warning would be outputted to the driver via display 4 and/or via loudspeaker 5.

In addition, a second value 27 is provided. However, the amplitude has not exceeded second value 27, not even with its maximum at time 25. Evaluation unit 10 compares the maximum of the received amplitude 28 with value 27. Here it is determined that the maximum of amplitude 28 is only 85% of the magnitude of value 27. As a result, for a subsequent distance measurement the sensitivity of the ultrasonic sensor is increased, because value 27 was undershot. As was explained in relation to FIG. 2, this can be accomplished by increasing a gain factor of amplifier 9. In an example embodiment, it is also possible to lower a threshold value in evaluation unit 10. In both cases, in principle the consequences are the same. This is explained with reference to the example of a signal shown in broken lines and reflected by an obstacle, received after later time 29. This could be for example a reflection from obstacle 15 of the signal sent out by first sensor 11. Between times 29 and 30, an increase and then a decrease of the envelope of a received signal are determined. If the maximum of the amplitude had yielded the value 27 at time 25 in the calibration measurements, a threshold value 33 would have been provided for a signal detection. The actually received and amplified signal 34, reflected by the obstacle, would then not have exceeded boundary value 33. A detection of the signal would not have taken place. Due to the reduction of the amplitude of the crosstalk signal, which had previously reached only the value 28, the threshold value is correspondingly reduced by the evaluation unit to a value 35 that is lower than the value 33. In this way, the received signal can exceed threshold value 35 at a time 36, and can thus be detected as a signal reflected by an obstacle. The same would also occur given a constant threshold value and a corresponding greater amplification of the received signal.

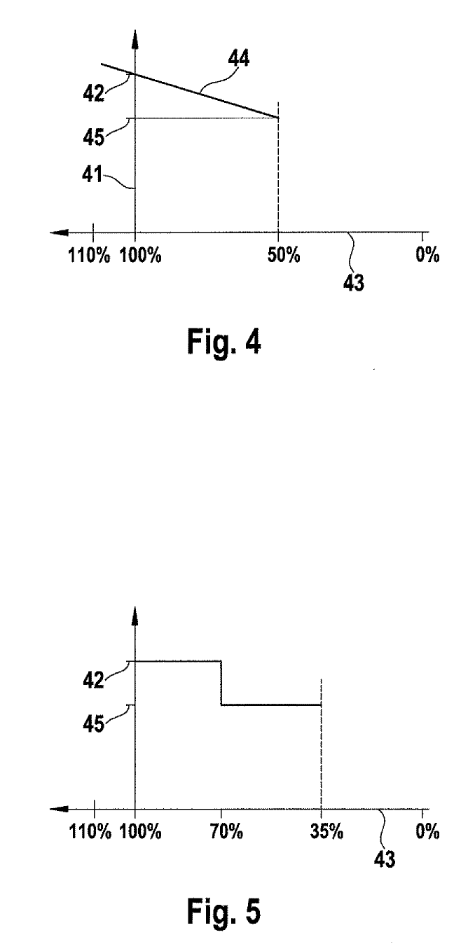

FIG. 4 shows an exemplary embodiment of a regulation of the dependence of the sensitivity of the sensor, dependent on a comparison with a prespecified value for the amplitude of the crosstalk signal. On the y-axis, the magnitude of a threshold value is shown without units, the value 42 being intended to correspond to a threshold value in a completely functional sensor. On the x-axis 43, the reaching of prespecified value 27 is plotted in percent. Moving to the right, the amplitude of the received crosstalk signal, transmitted without reflection, decreases. The curve of the threshold value decreases from an amplitude of the crosstalk signal of 100% to an amplitude of 50%; this is the threshold value that a received signal must exceed, corresponding in linear terms to a curve 44 down to the value 45, which represents for example 80% of value 42. If the amplitude falls below 50% of prespecified value 27, no threshold value is determined; rather, an error message is outputted stating that the ultrasonic sensor may be disturbed.

Value 27 for the comparison can be fixedly prespecified by the manufacturer. However, the value can also be set during installation of the ultrasonic sensors in the vehicle, in a first measurement. In addition, it is also possible to carry out a calibration via an operating element 40. If possible, this should take place in an environment in which no obstacles are present in front of ultrasonic sensors 11, 12, 13, 14. In this manner, the value can be written to storage device 17 in an updated manner. However, care should preferably be taken here that a minimum value is not undershot. In this manner, it can be ensured that aging or malfunctioning of the ultrasonic sensors can be taken into account during a calibration.

Depending on the conditions for a calibration, value 27 can also be exceeded in a subsequent measurement. In the example embodiment according to FIG. 4, here the threshold value can also again be raised, thus decreasing the sensitivity for subsequent measurements in order to enable exclusion of disturbances during detection. Here, the sensitivity can in the same way be suitably adapted by increasing a threshold value or by reducing the gain factor, as well as by a combination of both measures.

Even if obstacles are present in the vicinity of the vehicle during a calibration measurement, the sound path from first ultrasonic sensor 11 to second ultrasound extensor 12 in the direction of arrow 20 is shorter than a sound signal that is first reflected by an obstacle 15, unless the obstacle is situated very close in front of the ultrasonic sensors. If two maxima close to one another are acquired in the time interval in which the signal of the adjacent sensor should otherwise have been received, it is possible that an obstacle is situated too close to the vehicle. In this case as well, in an example embodiment an error message is outputted or the current calibration measurement is discarded.

FIG. 5 shows an exemplary embodiment for a dependence. In this case, the sensitivity of the ultrasound sensor is constant up to a decrease of the amplitude value of the crosstalk signal to 70% of the stored value. Subsequently, the sensitivity is reduced in the manner already explained by 20%, until the amplitude has reached a value of 35% of the stored value. Only below this value is an error message outputted stating that the ultrasonic sensor may be faulty. The dependence relation can be varied depending on the construction of the sensor, and its curve can be adapted.

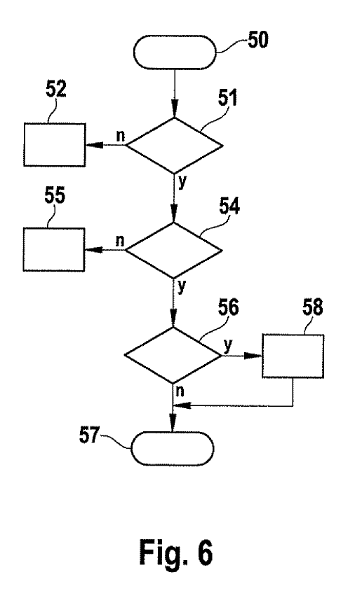

FIG. 6 shows a method sequence according to example embodiments of the present invention. The method can be carried out regularly, in particular upon activation of the distance measuring device. In addition, it can also be carried out when the vehicle is switched on.

In an initialization step 50, the ultrasonic sensor that is to be calibrated is switched to listening operation. In a first test step 51, it is checked whether a signal has arrived from an adjacent ultrasonic sensor. If necessary, a self-test of the transmitting sensor can be carried out in order to discover whether its vibrating membrane is excited to vibration. If no signal at all is received or sent out, at least one of the two sensors may be disturbed, and the method moves to a warning step 52 in which the user is warned of a possible malfunction of the distance-measuring device. The method terminates with this step. If, in contrast, it is determined that a corresponding crosstalk signal is received in an expected time window, branching takes place to a second testing step 54. In second testing step 54, it is checked whether the received ultrasonic signal exceeds a first boundary value (value 37). This first boundary value 37 can also be fixedly prespecified in non-volatile storage device 17. In an example embodiment, it is also possible to use for this boundary value a prespecified percent value of the value specified for the subsequent comparison for the purpose of calibration. If the first boundary value is undershot in second testing step 54, branching takes place to a warning step 55 in which a user may be warned of a possible non-functioning of the distance-measurement device.

The outputting of a warning in one of the testing steps can also be triggered as a function of state of a counter, so that a warning is outputted only if a prespecified number of successive undershootings of the first boundary value has been reached, e.g. five times.

If the first boundary value is exceeded, branching takes place to a third testing step 56. In third testing step 56, a comparison is carried out between the envelope of the amplitude and stored value 27. On the basis of the prespecified dependence, e.g. according to FIGS. 4 and 5, here it is determined whether a modification of the sensitivity of the ultrasonic sensor must be carried out. If this is not the case, branching takes place to an end step 57. A distance measurement to obstacles in the vicinity of the vehicle can now be carried out. If, in contrast, in third testing step 56 it is determined that the sensitivity of the ultrasonic sensor has to be readjusted in accordance with the prespecified rule for the dependence of the sensitivity of the ultrasonic sensor on the relation between the stored value 27 and amplitude 28, branching takes place to a corresponding controlling step 58, in which the corresponding setting of the sensitivity is carried out. As was already explained on the basis of FIGS. 2 and 3, here for example the gain factor in amplifier 9 can be modified. In addition, it is also possible to correspondingly vary the threshold value specified in evaluation unit 10 for a detection of a signal reflected by an obstacle. Subsequently, branching takes place to end step 57, followed by a distance measurement. The calibration can subsequently be carried out for the various ultrasonic sensors 11, 12, 13, 14. In addition, it is also possible, besides a calibration of the beginning of the measurement method, to repeat the calibration at prespecified time intervals.

The amplitude of the crosstalk signal arriving in the receiving sensor is dependent both on the current sensitivity of the receiving sensor and also on the current transmit power of the transmitting sensor, which can be reduced for example by dirt on the transmitter. This means that a low amplitude of the crosstalk signal can also be caused by an attenuation of the transmitting sensor. In order nonetheless to correctly regulate the sensitivity of the receiving sensor, for example during the setting of the sensitivity a plurality of adjacent sensors can act as transmitter in alternating fashion. In this way, a plurality of crosstalk signals can be compared with target values. The setting of the sensitivity of the receiving sensor then takes place using an algorithm that takes into account all values, or, in an example embodiment, takes into account only the highest value.

Another possibility is the setting of separate sensitivity levels of the receiving sensor for each transmitter. The sensitivity is then first varied only for a cross-echo mode. A setting for a direct-echo mode may subsequently through an evaluation of the amplitudes of signals that are reflected by real objects and received in cross-echo mode and in direct-echo mode.

FIG. 3 depicts an influencing of a fixed threshold value for sensitivity. In addition, it is also possible in a corresponding manner to modify a threshold value characteristic for the sensitivity of the ultrasonic sensor. The threshold value characteristic is described in particular by support points that are each for example connected to one another in linear fashion. In a corresponding manner, in which the threshold value is lowered for example by 10%, the value of a corresponding support point can also be lowered by 10%, so that the threshold value curve is shifted in a manner corresponding to the change in the support points.

If a reduced sensitivity is determined in the third testing step, in addition to an adaptation of the sensitivity of the ultrasonic sensor the range can also be decreased, for example through an earlier closing of the hearing window for an obstacle detection. Here, the driver should be informed of the reduced range via output devices 4, 5. The reduction in the range ensures that, given a higher sensitivity, signals from obstacles at a greater distance will not mistakenly be lost in a likewise amplified background noise, which could result in failure to issue a warning that a driver could have counted on based on the otherwise standard sensor range.

1-10. (canceled)

11. A method for calibrating an ultrasonic sensor, comprising:
sending out an ultrasonic signal by a first ultrasonic sensor;
transmitting the signal to a second ultrasonic sensor without being reflected by an obstacle;
receiving the signal by the second ultrasonic sensor that is to be calibrated;
comparing an amplitude of the received signal with a first stored value; and
setting a sensitivity level of the second ultrasonic sensor as a function of the comparison.

12. The method according to claim 11, wherein the sensitivity of the second ultrasonic sensor is increased if the amplitude of the received signal is less than the first stored value,

13. The method according to claim 11, wherein an error message is outputted if the amplitude of the received signal does not exceed a second value.

14. The method according to claim 11, wherein the first stored value is set in a separate calibration step.

15. The method according to claim 11, wherein given a higher set sensitivity level, a reduced range of the sensor is determined.

16. An ultrasonic distance-measuring device, comprising:
at least one first ultrasonic sensor;
at least one second ultrasonic sensor, the second ultrasonic sensor configured to receive an ultrasonic signal that is sent out by the first ultrasonic sensor and that reaches the second ultrasonic sensor without being reflected by an obstacle; and
a regulating unit configured to compare an amplitude of the received ultrasonic signal with a first stored value and to regulate a sensitivity level of the second ultrasonic sensor as a function of the comparison.

17. The device according to claim 16, wherein the at least two ultrasonic sensors are arranged in a bumper of a vehicle.

18. The device according to claim 16, wherein the regulating unit is configured to increase the sensitivity of the second ultrasonic sensor when a maximum of the amplitude of the received signal undershoots the first stored value.

19. The device according to claim 16, further comprising a warning unit configured to output a warning when the amplitude of the received signal decreases below a second, prespecified value.

20. The device according to claim 16, further comprising a non-volatile storage device configured to store a value for comparison with the amplitude of the received signal.
